(19) United States
(12) Patent Application Publication
(10) Pub. No.: US 2008/0238888 A1
(43) Pub. Date: Oct. 2, 2008

(54) IMAGE DETECTING DEVICE

(75) Inventors: Wei-Chou Chen, Tao-Yuan Hsien (TW); Kei-Hsiung Yang, Tao-Yuan Hsien (TW); Kun-Wei Lin, Tao-Yuan Hsien (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HANNSTAR DISPLAY CORP., Tao-Yuan Hsien (TW)

(21) Appl. No.: 11/829,502

(22) Filed: Jul. 27, 2007

(30) Foreign Application Priority Data
Apr. 2, 2007 (TW) 096111704

(51) Int. Cl. G06F 3/033

(52) U.S. Cl. 345/179

(57) ABSTRACT

An image detecting device is provided. The image detecting device includes a first shaft; a second shaft; a connecting shaft connected between the first and the second shafts; and an image detector mounted in one of the first shaft and the connecting shaft, wherein a first angle is formed between the first shaft and the connecting shaft, and a second angle is formed between the second shaft and the connecting shaft.

### FIELD OF THE INVENTION

The present invention relates to an image detecting device, and more particularly to an image detecting device with a multi-axial structure.

### BACKGROUND OF THE INVENTION

As the popularization of computers increases rapidly, the development and application of a pen-based input device in digital products progresses speedily. To fulfill multifunction requirements, the pen-based device is applied to the determination of the contact location of a touch panel, and to the detecting and receiving of patterns image or other information thereon. Furthermore, it is able to save the detected image records into memories, or transmit them to other data processing devices. For example, the electric pen in the U.S. Pat. No. 5,861,877 has functions of writing, transmitting data and outputting data. In the US Appl. No. 2006/0125971 A1, the inventors of the present application has provided a reflected infrared pattern made by a coding technique which is in cooperation with a monitor, such as a liquid crystal display, and the reflected infrared pattern is able to be identified and read by an image detecting device with an infrared emitter and an infrared receiver.

However, in the light reflection mechanism of optics, an incident angle of an incident light is equal to the reflecting angle of the reflecting light, which considerably limits the writing angle when operating an image detecting device with a light emitter and an image receiver. Please refer to FIG. 1(a), which is a schematic diagram of an infrared image detecting device 1 with an infrared emitter 15 and an infrared detector 10 therein. The infrared light is reflected by a plane 7 and detected by the infrared detector 10 after emitted from the infrared emitter 15. However, when the infrared image detecting device 1 slants, the angles of incidence and reflection increase, which results in a difficulty in detecting an infrared image.

A solution of the above drawback in the prior art is to enlarge the bore of the infrared image detecting device to broaden the detecting area of the reflecting light thereof. Please refer to FIG. 1(b), which shows a schematic diagram of an infrared image detecting device 1′, which is the infrared image detecting device 1 of FIG. 1(a) with an enlarged bore. Although the angle available to detect images increases when the infrared image detecting device 1′ slants, this method certainly causes inconveniences and a sight barrier for users.

Since there are several limitations when employing an image detecting device in the prior art, it is needed to provide a new image detecting device to overcome the above-mentioned problems.

### SUMMARY OF THE INVENTION

In accordance with one aspect of the present invention, an image detecting device with a multi-axial structure is provided. The image detecting device includes a first shaft, a second shaft, a connecting shaft and an image detector, wherein the image detector is mounted with one of the first shaft and the connecting shaft. Specifically, the image detector is mounted in or on one of the first shaft and the connecting shaft. In addition, a first angle is formed between the first shaft and the connecting shaft, and a second angle is formed between the second shaft and the connecting shaft, wherein the first and the second angles are adjustable and fixable. Moreover, the image detector is mounted in one of the interior of the first shaft and the interior of the connecting shaft, or mounted on one of the exterior of the first shaft and the exterior of the connecting shaft.

Preferably, the image detector is mounted with the first shaft to detect a light beam being parallel or coaxial to the axis of the first shaft.

Preferably, the sum of the first angle and the second angle is ranged from 155 to 195 degree.

Preferably, the first angle is ranged from 45 to 75 degree.

Preferably, the sum of the first angle and the second angle is 180 degree. Namely, the first angle and the second angle are supplementary.

Preferably, the first shaft, the connecting shaft, and the second shaft are disposed to be in the same plane.

Preferably, the first shaft has an opening, and the image detector is mounted in the interior of the first shaft and detects a light beam being parallel or coaxial to an axis of the first shaft via the opening.

Preferably, the image detecting device further contains a connection device such as a pivot structure, wherein the first shaft is connected to the connecting shaft, and the first angle is adjusted and fixed by the connection device. Besides, the second shaft is also connected to the connecting shaft by the same type of connection device. That is, the angle between the first shaft and the second shaft of the image detecting device in the present invention are adjustable according to the angle of the image emitted or detected, or according to the user's comfort.

In accordance with another aspect of the present invention, an image detecting device with a multi-axial structure is provided. The image detecting device includes a first shaft, a second shaft, a connecting portion connected between the first and the second shafts, and an image detector mounted with one of the first shaft and the connecting portion, wherein the connecting portion contains a third shaft not coaxial to the first shaft and the second shaft, a first connecting shaft connected between the first and the third shafts, and a second connecting shaft connected between the second and the third shafts. Moreover, a first angle is formed between the first shaft and the second connecting shaft, and a second angle is formed between the second shaft and the second connecting shaft.

Preferably, the sum of the first angle and the second angle is ranged from 155 to 195 degree.

Preferably, the sum of the first angle and the second angle is 180 degree. Namely, the first angle and the second angle are supplementary.

Preferably, the image detector is mounted on one of the exterior of the first shaft and the exterior of the connecting portion, or mounted in one of the interior of the first shaft and the interior of the connecting portion.

Additional objects and advantages of the invention will be set forth in the following descriptions with reference to the accompanying drawings, in which:

### BRIEF DESCRIPTION OF THE DRAWINGS

FIG. 1(a) is a schematic diagram showing an infrared image detecting device in the prior art;

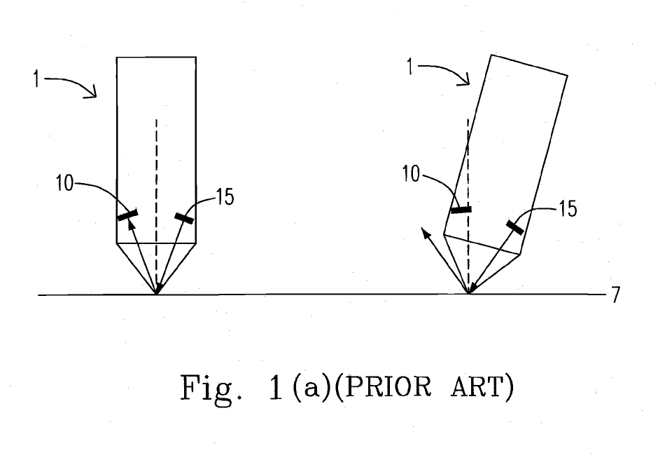

FIG. 1(b) is a schematic diagram showing the infrared image detecting device of FIG. 1(a) with an enlarged bore;

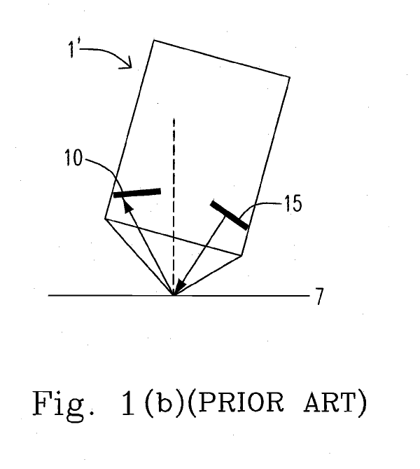

FIG. 2(a) shows the image detecting device according to a first preferred embodiment of the present invention;

FIG. 2(b) shows the image detecting device according to a second preferred embodiment of the present invention;

FIG. 2(c) is a schematic diagram showing the locations of the respective components at the exterior of the image detecting device in the present invention;

FIG. 3(a) shows the image detecting device according to a third preferred embodiment of the present invention;

FIG. 3(b) shows the image detecting device according to a fourth preferred embodiment of the present invention;

FIG. 3(c) is a schematic diagram showing the locations of respective adjustable components of the image detecting device in the present invention;

FIG. 4(a) shows the image detecting device according to a fifth preferred embodiment of the present invention;

FIG. 4(b) shows the image detecting device according to a sixth preferred embodiment of the present invention; and

FIG. 5 shows the image detecting device according to a seventh preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

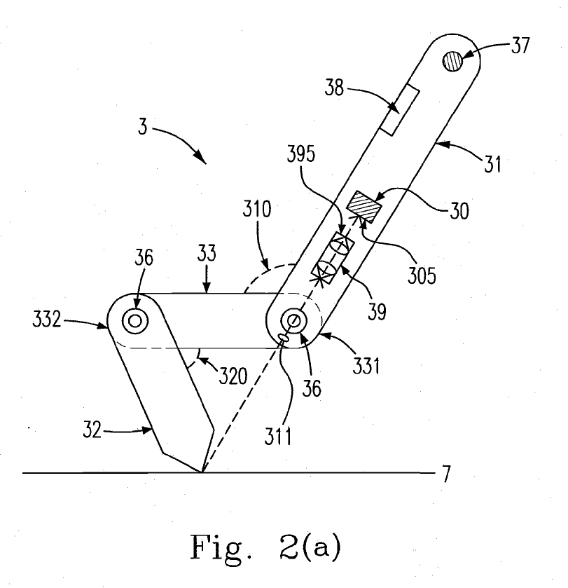

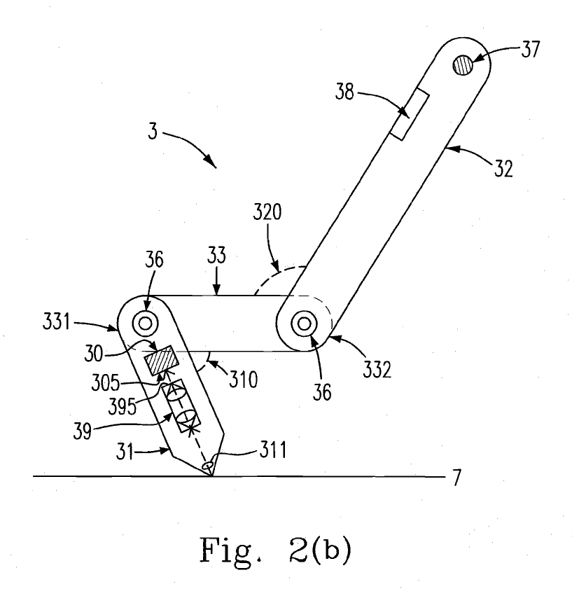

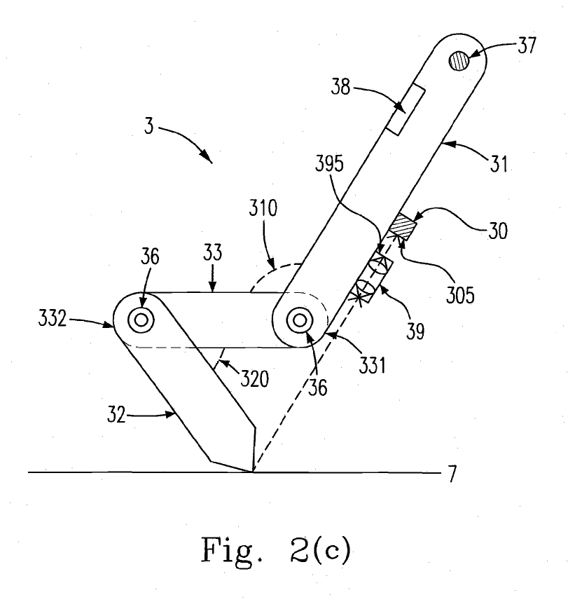

Please refer to FIG. 2(a), which shows a schematic diagram of an image detecting device according to the first embodiment of the present invention. The image detecting device 3 includes a first shaft 31, a connecting shaft 33 and a second shaft 32, wherein the connecting shaft 33 has a first terminal 331 and a second terminal 332. The first terminal 331 is connected to the first shaft 31 and a first angle 310 is accordingly formed therebetween, while the second terminal 332 is connected to the second shaft 32 and a second angle 320 is accordingly formed therebetween, wherein the sum of the first angle 310 and the second angle 320 can be ranged from 155 to 195 degree, but not limited thereto, and further the first angle 310 can be preferably designed to be ranged from 80 to 150 degree as well as accordingly the second angle 320 can be ranged from 45 to 75 degree; also in another embodiment, the sum of the first angle 310 and the second angle 320 is preferably 180 degree, and further the first angle 310 can be preferably designed to be 120 degree as well as accordingly the second angle 320 can be 60 degree.

As shown in FIG. 2(a), an image detector 30 is mounted with the first shaft 31 to detect a light beam being parallel or coaxial to the axis of the first shaft 31, and the first shaft 31 is a holding shaft while the second shaft 32 is a writing shaft. Since the biaxial structure design of the image detecting device 3 has different axes, the writing shaft and the holding shaft, it overcomes the drawbacks of the angle limitations in writing and detecting the image of a pattern or other information on a plane 7. The plane 7 can be a pattern plane, e.g. a reflected infrared pattern, in a liquid crystal display or other display device.

Please refer to FIG. 2(b), which shows another schematic diagram of the image detecting device 3 according to the second embodiment of the present invention, wherein the first shaft 31 is a writing shaft and the second shaft 32 is a holding shaft. A first angle 310 is accordingly formed between the connecting shaft 33 and the first shaft 31, while a second angle 320 is accordingly formed between the connecting shaft 33 and the second shaft 32, wherein the sum of the first angle 310 and the second angle 320 can be ranged from 155 to 195 degree, but not limited thereto, and further the first angle 310 can be preferably designed to be ranged from 45 to 75 degree as well as accordingly the second angle 320 can be ranged from 80 to 150 degree; also in another embodiment, the sum of the first angle 310 and the second angle 320 is preferably 180 degree, and further the first angle 310 can be preferably designed to be 60 degree as well as accordingly the second angle 320 can be 120 degree. In the second embodiment, the image detector 30 is mounted with the writing shaft to detect a light beam being parallel or coaxial to the axis thereof, which is different from the first embodiment. In other words, the image detector 30 can be mounted either with the holding shaft of the image detecting 3 as FIG. 2(a) shows or with the writing shaft thereof as FIG. 2(b) shows.

Moreover, the image detecting device 3 shown in FIG. 2(a) and FIG. 2(b) contains a switch device 37 electrically connected to the image detector 30 to control the turning on/off of the image detecting device 3 and also contains a power supply 38 electrically connected to the switch device 37 to provide a power for the image detecting device 3. Preferably, the power supply 38 is a battery but is not limited thereto.

Further refer to FIG. 2(a) and FIG. 2(b), the first shaft 31 further respectively contains an optical-lens assembly device 39, which includes at least one optical lens and is adjustable to make an imaging plane 395 thereof parallel to a receiving plane 305 of the image detector 30. It is to be noted that the switch device 37 and the power supply 38 of the above-mentioned embodiments are not limited to be mounted with the holding shaft or the writing shaft. In another embodiments, the switch device 37 and the power supply 38 can be mounted in or on any appropriate locations of the image detecting device 3 where they are easy to be operated or installed; namely, the switch device 37 and the power supply 38 can be respectively mounted on an appropriate location at the exterior of any shaft or mounted in an appropriate location at the interior of any shaft. Further, the image detector 30 and the optical-lens assembly device 39 can also be mounted in or on any appropriate locations of the image detecting device 3 where they are easy to be operated or installed, and that the image detector 30 and the optical-lens assembly device 39 are mounted with the writing shaft or the holding shaft described in the invention means they can either be respectively mounted in the interior of the writing shaft or the holding shaft of the image detecting device 3 as shown in FIG. 2(a) and FIG. 2(b) or mounted on the exterior of the writing shaft or the holding shaft as shown in FIG. 2(c). As shown in FIG. 2(a) and FIG. 2(b), when the image detector 30 is mounted in the interior of the first shaft 31, the first shaft 31 has an opening 311 to allow the image detector 30 to detect the light beam being parallel or coaxial to the axis of the first shaft 31 via the opening 311.

Please refer to FIG. 2(a) and FIG. 2(b), which show the image detecting device 3 according to the embodiment, wherein the first shaft 31, the connecting shaft 33 and the second shaft 32 are deposed to being in the same plane.

Please refer to FIG. 2(a) and FIG. 2(b) again, which show the image detecting device 3 according to the embodiment, wherein a connecting device 36 is disposed at the connecting point between the first shaft 31 and the first terminal 331. The connecting device 36 is a fixing device to fix the relative location between the first shaft 31 and the connecting shaft 33, or is an adjusting device to adjust the first angle 310, such as a pivot structure or any mechanical device for connecting the two shafts and adjusting the angle therebetween. In addition, another connecting device 36 is disposed at the connecting point between the second shaft 32 and the second terminal 332, which is also a fixing device or an adjusting device to adjust the second angle 320.

Preferably, please refer to the image detecting device 3 shown in FIG. 2(a) and FIG. 2(b), wherein the image detector 30 is an infrared image detector but is not limited thereto. Other conventional image detectors are also applicable.

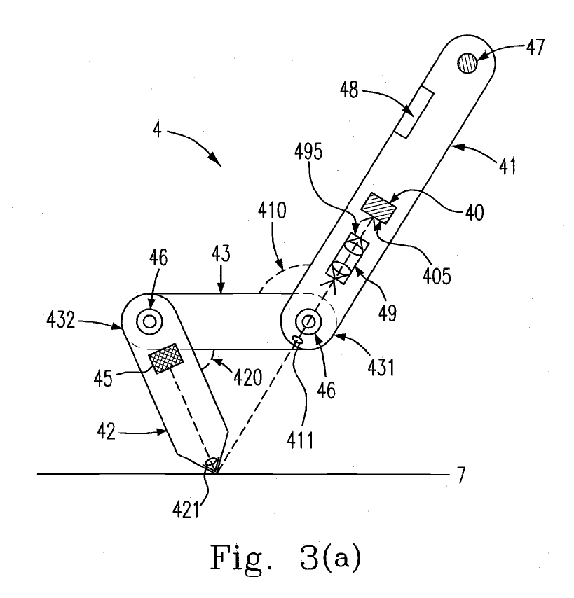

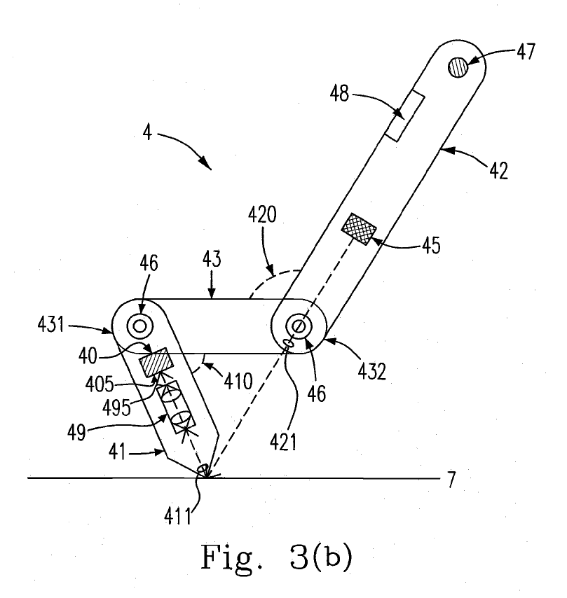

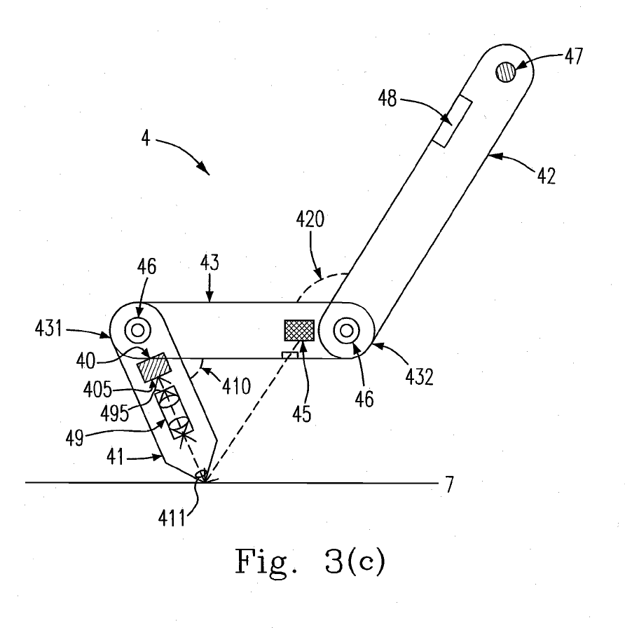

Please refer to FIG. 3(a), which shows the image detecting device according to the third embodiment of the present invention. Preferably, the image detecting device 4 includes a first shaft 41, a connecting shaft 43 and a second shaft 42, wherein the connecting shaft 43 has a first terminal 431 and a second terminal 432. The first terminal 431 is connected to the first shaft 41 and a first angle 410 is accordingly formed therebetween, and the second terminal 432 is connected to the second shaft 42 and a second angle 420 is accordingly formed therebetween, wherein the sum of the first angle 410 and the second angle 420 can be ranged from 155 to 195 degree, but not limited thereto, and further the first angle 410 can be preferably designed to be ranged from 80 to 150 degree as well as accordingly the second angle 420 can be ranged from 45 to 75 degree; also in another embodiment, the sum of the first angle 410 and the second angle 420 is preferably 180 degree, and further the first angle 410 can be preferably designed to be 120 degree as well as accordingly the second angle 420 can be 60 degree. A connecting device 46 is disposed at the connecting point between the first shaft 41 and the first terminal 431, which is either a fixing device to fix the relative location between the first shaft 41 and the connecting shaft 43, or an adjusting device to adjust the first angle 410 such as a pivot structure or any mechanical device to connect the two shafts and adjust the angle therebetween. In addition, another connecting device 46 is disposed at the connecting point between the second shaft 42 and the second terminal 432, which is either a fixing device or an adjusting device for adjusting the second angle 420.

As shown in FIG. 3(a), the first shaft 41 has an image detector 40 and an optical-lens assembly device 49, while the second shaft 42 has an emitter 45 to emit a light beam parallel or coaxial to the axis of the second shaft 42. Moreover, the first shaft 41 is a holding shaft, and the second shaft 42 is a writing shaft.

As shown in FIG. 3(a), preferably, the image detector 40 is an infrared image detector, and the emitter 45 is an infrared emitter, but both of them are not limited thereto. In another embodiment, the emitter 45 can be a LED or other light sources. In addition, when the emitter 45 is mounted in the interior of the second shaft 42 and the image detector 40 is mounted in the interior of the first shaft 41, the first shaft 41 has a first opening 411 while the second shaft 42 has a second opening 421, and the light emitted outside via the second opening 421 from the emitter 45 is received by the image detector 40 via the first opening 411 after reflected by a plane 7. Due to the biaxial structure design of the image detecting device 4, with different axes between the writing shaft and the holding shaft, and the adjustable angles therebetween can be adjusted by the connecting devices 46, the receiving angle of the reflected light of the image detector 40 is less limited, which overcomes the drawback of the angle limitation of the image detecting device for writing and image receiving in the prior art.

Please refer to the image detecting device according to the fourth embodiment of the present invention shown in FIG. 3(b), which is another structure schematic diagram of the image detecting device 4, wherein the first shaft 41 is a writing shaft, and the second shaft 42 is a holding shaft. In other words, the image detector 40 of the image detecting device 4 is either mounted with the holding shaft thereof as shown in FIG. 3(a) while the emitter 45 is mounted with the writing shaft thereof, or is mounted with the writing shaft thereof as shown in FIG. 3(b) while the emitter 45 is mounted with the holding shaft thereof.

Please refer to the image detecting device 4 according to the fourth embodiment of the present invention shown in FIGS. 3(a) and 3(b), wherein the first shaft 41, the connecting shaft 43 and the second shaft 42 are deposed to be in the same plane.

Furthermore, the image detecting device 4 shown in FIGS. 3(a) and 3(b) further contains a switch device 47 electrically connected to the image detector 40 or the emitter 45 to control a turning on/off of the image detecting device 4.

Please refer to the fourth embodiment shown in FIGS. 3(a) and 3(b), wherein the image detecting device 4 further contains a power supply 48 electrically connected to the switch device 47 to provide a power for the image detecting device. Preferably, the power supply 48 is a battery.

Please refer to the image detecting device 4 shown in FIGS. 3(a) and 3(b), wherein the optical-lens assembly device 49 includes at least one lens and is adjustable to make an imaging plane 495 thereof parallel to a receiving plane 405 of the image detector 40. Preferably, the light emitted from the emitter 45 of the image detecting device 4 is parallel or coaxial to the axis of the second shaft 42.

Notably, as shown in FIG. 3(c), the emitter 45 in the above-mentioned preferred embodiment can be mounted with the connecting shaft 43 other than in the second shaft 42. Moreover, other components such as the image detector 40, the switch device 47 and the power supply 48 are not limited to be mounted in the interior locations of the holding shaft, the writing shaft or the connecting shaft, but also can be mounted on the appropriate exterior locations of each shafts or at any appropriate location of the image detecting device 4, which are easy to operate and install.

In addition, the first shaft, the second shaft and the connecting shaft are connected to each other by the connecting devices 46, and the relative angles therebetween are adjusted thereby in the respective above-mentioned embodiments. However, in another embodiment, the first shaft, the second shaft and the connecting shaft can be fabricated as a one-piece structure.

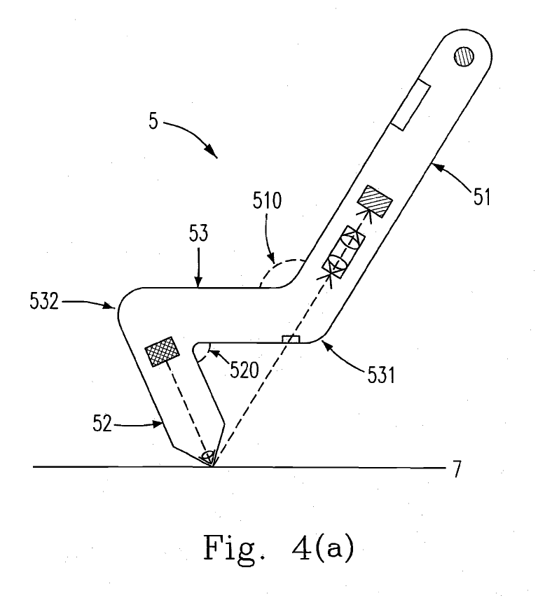

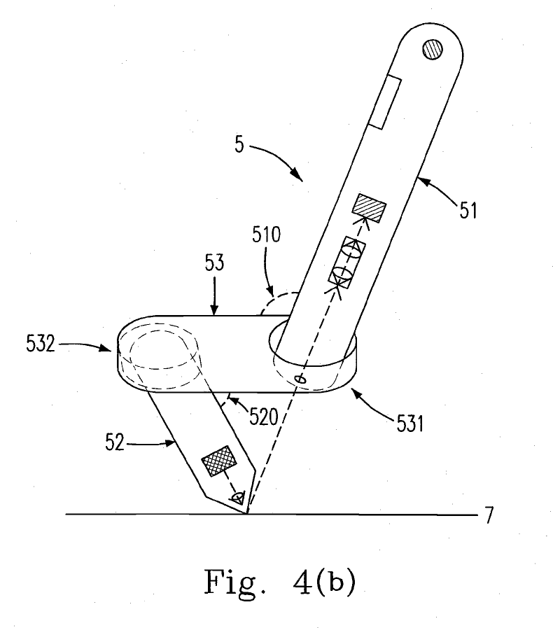

Please refer to the fifth embodiment of the present invention shown in FIG. 4(a), wherein the image detecting device 5 includes a first shaft 51, a second shaft 52 and a connecting shaft 53. A first angle 510 is accordingly formed between the first shaft 51 and the connecting shaft 53, and a second angle 520 is accordingly formed between the second shaft 52 and the connecting shaft 53, wherein the sum of the first angle 510 and the second angle 520 can be ranged from 155 to 195 degree, but not limited thereto, and further the first angle 510 can be preferably designed to be ranged from 80 to 150 degree as well as accordingly the second angle 520 can be ranged from 45 to 75 degree; also in another embodiment, the sum of the first angle 510 and the second angle 520 is preferably 180 degree, and further the first angle 510 can be preferably designed to be 120 degree as well as accordingly the second angle 520 can be 60 degree. Furthermore, first shaft 51, the second shaft 52 and the connecting shaft 53 are a one-piece structure so that the connecting devices mentioned in the respective above-mentioned embodiments are unnecessary. The material of the shafts of the image detecting device 5 can be metal or non-metal material. Preferably, the material thereof is a malleable material, and thereby the user can bend at the first terminal 531 and the second terminal 532 of the connecting shaft 53 to adjust the first angle 510 and the second angle 520 when using the image detecting device 5. Please refer to the sixth embodiment of present invention shown in FIG. 4(b), wherein the connecting devices mentioned in the first to fourth embodiments are unnecessary to be disposed at the connection points between the first shaft 51 and the connecting shaft 53 and that between the second shaft 52 and the connecting shaft 53. The connection mechanisms at the connection points are designed as an adjustable connecting structure, such as a bolt combination, wherein the first angle 510 and the second angle 520 are adjustable. Besides, the configurations and the alternatives of the relative locations of the components such as the image detector, the emitter and the optical-lens assembly device are the same as the above-mentioned embodiments.

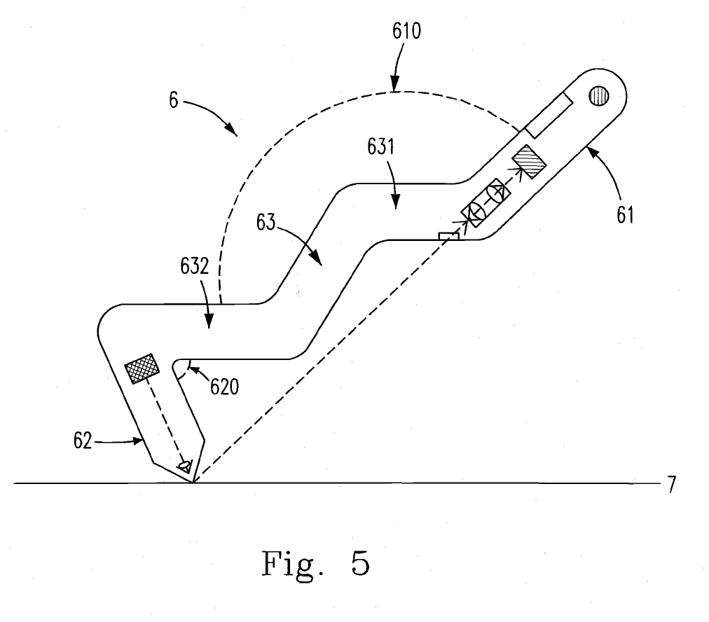

Notably, although the above image detecting devices according the above embodiments are biaxial structures, they are not limited thereto. The image detecting device according to the present invention can also be multi-axial structure, such as the image detecting device 6 with tri-axial structure according to another embodiment shown in FIG. 5, which contains a first shaft 61, a second shaft 62, a connecting portion containing a third shaft 63, a first connecting shaft 631 and a second connecting shaft 632, wherein a first angle 610 is formed between the axis of the first shaft 61 and the axis of the second connecting shaft 632, and a second angle 620 is formed between the axis of the second shaft 62 and the axis of the second connecting shaft 632. Both of the first angle 610 and the second angle 620 are either fixed or adjustable, and the angle between the third shaft 63 and the first connecting shaft 631, as well as the angle between the third shaft 63 and the second shaft 632, are designed as a fixed or adjustable one. Besides, the sum of the first angle 610 and the second angle 620 can be ranged from 155 to 195 degree, and the third shaft 63 is not coaxial to the first shaft 61 and the second shaft 62, but not limited thereto, and in another embodiment, the sum of the first angle 610 and the second angle 620 is preferably 180 degree. Moreover, the image detecting device according to the embodiment of the present invention is presented as a pen-shape but is not limited thereto; it can also be a “hold-able” device in any shape with multi-axial structure.

In conclusion, through the multi-axial structure of the image detecting device in the present invention, the image emitter and the image detector are located at different axes thereof, which overcome the limitations of the writing angle and the image receiving/detecting angle. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image detecting device, comprising:
a first shaft;
a second shaft;
a connecting shaft connected between the first and the second shafts; and
an image detector mounted with one of the first shaft and the connecting shaft,
wherein a first angle is formed between the first shaft and the connecting shaft, and a second angle is formed between the second shaft and the connecting shaft.

2. An image detecting device according to claim 1, wherein the image detector is mounted with the first shaft to detect a light beam being parallel or coaxial to an axis of the first shaft.

3. An image detecting device according to claim 1, wherein a sum of the first angle and the second angle is ranged from 155 to 195 degree.

4. An image detecting device according to claim 3, wherein the first angle is ranged from 45 to 75 degree.

5. An image detecting device according to claim 1, wherein a sum of the first angle and the second angle is 180 degree.

6. An image detecting device according to claim 1, wherein the first shaft, the connecting shaft, and the second shaft are disposed to be in the same plane.

7. An image detecting device according to claim 1, wherein the first shaft, the connecting shaft, and the second shaft are formed as a one-piece structure.

8. An image detecting device according to claim 7, wherein the first shaft, the connecting shaft, and the second shaft are made of a malleable material.

9. An image detecting device according to claim 1, wherein the first angle and the second angle are adjustable.

10. An image detecting device according to claim 1, further comprising a connection device, wherein the first shaft is connected to the connecting shaft by the connection device.

11. An image detecting device according to claim 1, wherein the connection device comprises a pivot structure, and the first angle is adjusted thereby.

12. An image detecting device according to claim 1, further comprising a connection device, wherein the second shaft is connected to the connecting shaft by the connection device.

13. An image detecting device according to claim 1, wherein the image detector is mounted in one of the interior of the first shaft and the interior of the connecting shaft.

14. An image detecting device according to claim 1, wherein the first shaft has an opening, and the image detector is mounted in the interior of the first shaft and detects a light beam being parallel or coaxial to an axis of the first shaft via the opening.

15. An image detecting device according to claim 1, wherein the image detector is mounted on one of the exterior of the first shaft and the exterior of the connecting shaft.

16. An image detecting device according to claim 1, wherein the first shaft is a holding shaft, and the second shaft is a writing shaft.

17. An image detecting device according to claim 1 further comprising a switch device electrically connected to the image detector to control a turning on/off of the image detecting device.

18. An image detecting device according to claim 17 further comprising a power supply electrically connected to the switch device to provide a power for the image detecting device.

19. An image detecting device according to claim 1 further comprising an optical-lens assembly device, wherein the image detector detects an image through the optical-lens assembly device.

20. An image detecting device according to claim 19, wherein the optical-lens assembly device is adjustable to make an imaging plane thereof parallel to a receiving plane of the image detector.

21. An image detecting device according to claim 1, further comprising an emitter mounted with one of the second shaft and the connecting shaft.

22. An image detecting device according to claim 21, wherein the emitter is mounted with the second shaft, and a light beam emitted therefrom is parallel or coaxial to an axis of the second shaft.

23. An image detecting device according to claim 21, wherein the second shaft has an opening, and the emitter is mounted in the interior of the second shaft and emits a light beam being parallel or coaxial to an axis of the second shaft outside via the opening.

24. An image detecting device, comprising:
a first shaft;
a second shaft;
a connecting portion connected between the first and the second shafts, comprising:
a third shaft not coaxial to the first shaft and the second shaft;
a first connecting shaft connected between the first and the third shafts; and
a second connecting shaft connected between the second and the third shafts; and
an image detector mounted with one of the first shaft and the connecting portion,
wherein a first angle is formed between the first shaft and the second connecting shaft, and a second angle is formed between the second shaft and the second connecting shaft.

25. An image detecting device according to claim 24, wherein a sum of the first angle and the second angle is ranged from 155 to 195 degree.

26. An image detecting device according to claim 24, wherein a sum of the first angle and the second angle is 180 degree.
